(19) United States
(12) Patent Application Publication
(10) Pub. No.: US 2011/0182055 A1
(43) Pub. Date: Jul. 28, 2011

(54) Photoluminescent Light Source

(75) Inventors: Udayan Kanade, Pune (IN); Pushkar Apte, Rochester, NY (US); Ruby Rama Praveen, Pune (IN); Sanat Ganu, Pune (IN); Sumeet Katariya, Pune (IN); Alok Deshpande, Madison, WI (US); Parag Khairnar, Bengaluru (IN)

(73) Assignee: I2IC CORPORATION, Foster City, CA (US)

(21) Appl. No.: 12/933,432

(22) PCT Filed: Mar. 19, 2009
(86) PCT No.: PCT/IB2009/051173

§ 371 Date: Feb. 1, 2011

(30) Foreign Application Priority Data
Mar. 19, 2008 (IN) 555/MUM/2008

(51) Int. Cl. F21V 9/16

(52) U.S. Cl. 362/84

(57) ABSTRACT

A photo luminescent light source is disclosed. In one embodiment, the apparatus comprises a light conducting medium. This light conducting medium includes particles of photoluminescent material, and a light source placed along an edge of it. The photoluminescent material absorbs light generated by the light source, and emanates light of the wavelength characterized by the photoluminescence properties of particles. The distribution of light emitting photoluminescent particles is varied throughout the medium to emanate a predetermined light pattern. In another embodiment, the light source emits light of multiple colors. In yet another embodiment, the light source emits polarized light.

This application claims priority from provisional patent application number 555/MUM/2008 titled “Photoluminescent Light Source” dated 19 Mar. 2008 filed in Mumbai, India.

### TECHNICAL FIELD

The present invention relates to an illumination system. Particularly, the invention relates to an illumination system comprising a light conducting medium with photoluminescent material.

### BACKGROUND ART

Illumination is used to light objects for seeing, as also for photography, microscopy, scientific purposes, entertainment productions (including theater, television and movies), projection of images and as backlights of displays.

For illumination purposes, the present art has many systems in the form of point or single dimensional sources of light. Such systems have many drawbacks: light intensity is very high at the light source compared to the rest of the room or environment, and thus such light sources are hurtful to the eye. Such sources also cast very sharp shadows of objects, which are not pleasing to the eye, and may not be preferred for applications such as photography and entertainment production. Such sources also cause glare on surfaces such as table tops, television front panels and monitor front panels.

There are prior systems that act as light sources in the form of a surface. Fluorescent lights for home lighting may be covered by diffuser panels to reduce the glare. These systems are bulky. Diffusers and diffused reflectors such as umbrella reflectors are used as light sources for photography and cinematography, but they are only approximations to uniform lighting.

Backlights of flat panel screens such as LCD screens provide uniform or almost uniform light. Prior solutions for backlighting an LCD screen is to have a light guide in the form of a sheet, with some shapes such as dots or prisms printed on it to extract light. The light guide is formed by sandwiching a high refractive index material between two low refractive index materials. The shape and frequency of dots is managed such that uniform illumination over the surface is achieved. These methods give uniform illumination over the surface, but the illumination is not uniform locally—when looked at closely the appearance is that of dots of glowing light surrounded by darkness. Such non-uniformity is not pleasing to the eye, and will cause disturbing Moiré patterns if used as a backlight for a flat panel screen. Such systems, to achieve local uniformity of light, need to be covered by diffuser panels or film, which makes them costlier and bulkier.

There are systems which provide uniform illumination over a surface in the local sense, i.e. locally, a surface is uniformly illuminated. These systems are similar to the systems described above, in the sense that they use a light guide and a method of extracting part of the light being guided. The light extraction, though, is not done with dots or geometric shapes, but with microscopic light scattering, diffracting or diffusing particles. Such particles are distributed uniformly throughout the light guide. This causes a continuously lighted light source, rather than one that is discretely lighted.

On the other hand, as the light is guided from one end of the sheet to another, part of the light is extracted, causing lesser and lesser light left for extracting, and thus lesser and lesser illumination. Thus, these systems do not provide uniformity of illumination over the entire surface. To provide approximate uniformity, the total drop in light from one end of the light guide to the other should not be too large. This causes light to be wasted at the edge of the light guide, and thus the energy efficiency of the system goes down.

Optical waveguide in the form of an optical fiber is used for multiple applications. Present systems use optical fiber as an efficient light guide for large bandwidth, fast communication. Optical fibers are also used in fiber-optic sensors. Prior art systems use optical waveguide in imaging optics including medical applications. Doped optical fiber is used as the gain medium of a laser or as an optical amplifier. Present optoelectronic systems also use optical fiber for supplying power to low power electronic circuits situated in difficult electrical environments.

Prior art systems also use optical fiber as a light guide for decorative illumination. Optical fibers doped with scintillator material are used for radiation detection. Fibers doped with photoluminescent particles, commonly known as ‘fluorescent fibers’ are found to be used in study kits in order to study the light guiding properties of the optical fiber. Photoluminescent fibers (with light gathering fluorescent material) are also used in sights of day-night weapons.

Light from most light sources is randomly polarized. However, several applications require linearly or circularly polarized light to function properly. For example, many light valves such as liquid crystal light valves and optical processors require linearly polarized light. Prior art systems exist which convert randomly polarized light to polarized light. Some prior art systems use a polarizer in front of the light source. Unpolarized light passes through the polarizer and polarized light emerges out from it. Such systems are inefficient since polarizers allow transmission of one polarization component but absorb the other polarization component. Thus approximately half the light energy is dissipated in the polarizer. Other prior art systems use polarizing beam splitters for polarizing light. Polarizing beam splitters allow the required polarization component to pass through, however, the unwanted polarization component is deflected away and its energy is dissipated elsewhere. Therefore, such systems are also inefficient.

Flat screen color displays present in the art normally use illumination in the form of white light. The white light falls on the display such as LCD which uses color filters to depict colors. Color filters reduce efficiency of the display since large amount of light is absorbed. Another disadvantage is that because of the color filters the transmittance of the display is very low.

Another method known in the art is to stack dyed nematic crystal panels one after the other. White light is passed through them. Each layer subtracts some amount of the red, blue and green respectively from the white light according to the voltage applied to it and displays the colored image. But this also has a disadvantage of loss of light and hence reduced efficiency. It also suffers from parallax errors.

Luminescence is emission of light different from incandescence, in that it usually occurs at low temperatures and thus differs from radiation from hot bodies. It can be caused by, for example, chemical reactions, electrical energy, subatomic motions, or stress on a crystal. Photoluminescence is a process in which a chemical compound absorbs photons (electromagnetic radiation), thus jumping to a higher electronic energy state, and then radiates photons back out, returning to a lower energy state. In other words, photoluminescence is luminescence arising from photoexcitation. Photoluminescent substances include substances which exhibit photoluminescence in the form of fluorescence, phosphorescence or scintillation.

Fluorescence is a luminescence that is mostly found as an optical phenomenon in cold bodies, in which the molecular absorption of a photon triggers the emission of another photon with a longer wavelength. Phosphorescence is also a form of photoluminescence, differing from fluorescence in the sense that energy absorbed by phosphorescent substance is released slower and for longer time than that in fluorescent material. Scintillation is a process in which a substance absorbs high energy electromagnetic or charged particle radiation and fluoresces photons at a characteristic longer wavelength, releasing the previously absorbed energy.

### DISCLOSURE OF INVENTION

### Summary

A photo luminescent light source is disclosed. In one embodiment, the apparatus comprises a light conducting medium. This light conducting medium includes particles of photoluminescent material, and a light source placed along an edge of it. The photoluminescent material absorbs light generated by the light source, and emanates light of the wavelength characterized by the photoluminescence properties of particles. The distribution of light emitting photoluminescent particles is varied throughout the medium to emanate a predetermined light pattern. In another embodiment, the light source emits light of multiple colors. In yet another embodiment, the light source emits polarized light.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1A illustrates a photoluminescent light source, according to one embodiment.

FIG. 1B illustrates a photoluminescent light source as viewed from the side, according to one embodiment.

FIG. 1C illustrates a photoluminescent light source, according to one embodiment.

FIG. 2 illustrates an exemplary core element of a core, according to one embodiment.

FIG. 3 illustrates a photoluminescent light source with a core having a varied concentration of photoluminescent particles, according to one embodiment.

FIG. 4 illustrates a photoluminescent light source having two primary light sources, according to one embodiment.

FIG. 5 illustrates a photoluminescent light source having a mirrored core, according to one embodiment.

FIG. 6 is a flow diagram illustrating an exemplary core manufacturing process, according to one embodiment.

FIG. 7A illustrates an exemplary base liquid having varying concentrations of photoluminescent particles, according to one embodiment.

FIG. 7B illustrates an exemplary core, according to one embodiment of the present invention.

FIG. 7C illustrates an exemplary base liquid having compartments, according to one embodiment.

FIG. 8 illustrates a block diagram of an apparatus for manufacturing a core, according to one embodiment of the present invention.

FIG. 9 is a flow diagram illustrating an exemplary process of manufacturing a core with a varying concentration of photoluminescent particles, according to one embodiment.

FIG. 10 is a flow diagram illustrating an exemplary process of manufacturing a core with a varying concentration of photoluminescent particles, according to one embodiment.

FIG. 11A illustrates a partitioned cast, according to one embodiment.

FIG. 11B illustrates a partitioned cast filled with liquid, according to one embodiment.

FIG. 11C illustrates a cast with partition removed, according to one embodiment.

FIG. 11D illustrates an apparatus with diffused bodies, according to one embodiment.

FIG. 12 is a flow diagram illustrating an exemplary process of manufacturing a core with a varying concentration of photoluminescent particles, according to one embodiment.

FIG. 13A illustrates a container with curved object, according to one embodiment.

FIG. 13B illustrates a container with curved object filled with liquid, according to one embodiment.

FIG. 13C illustrates a container with solidifying liquid, according to one embodiment.

FIG. 14A illustrates an exemplary corrugated sheet manufacturing device, according to one embodiment.

FIG. 14B illustrates an exemplary core manufacturing device, according to one embodiment.

FIG. 14C illustrates an exemplary core manufacturing device, according to one embodiment.

FIG. 15A illustrates a light source that emanates light from a single surface, according to one embodiment.

FIG. 15B illustrates a light source that emanates light from a single surface, according to one embodiment.

FIG. 15C illustrates a partially mirrored light source, according to one embodiment.

FIG. 16 illustrates an exemplary light source with multiple light conducting mediums, according to one embodiment of the present invention.

FIG. 17 illustrates a block diagram of an exemplary backlight display, according to one embodiment.

FIG. 18A is the top view of an illuminator column, according to one embodiment.

FIG. 18B is the cross-sectional side view of an illuminator column, according to one embodiment.

FIG. 18C is the front view of an illuminator column, according to one embodiment.

FIG. 19A illustrates a section of a polarized light source, according to one embodiment.

FIG. 19B illustrates a section of a polarized light source, depicting polarization states of exemplary light rays, according to one embodiment.

### DETAILED DESCRIPTION

A photo luminescent light source is disclosed. In one embodiment, the apparatus comprises a light conducting medium. This light conducting medium includes particles of a photoluminescent material, and a light source placed along an edge of it. The photoluminescent material absorbs light generated by the light source, and emanates light of the wavelength characterized by the photoluminescence properties of particles. The distribution of light emitting photoluminescent particles is varied throughout the sheet to emanate a predetermined light pattern. In another embodiment, the light source emits light of multiple colors. In yet another embodiment, the light source emits polarized light.

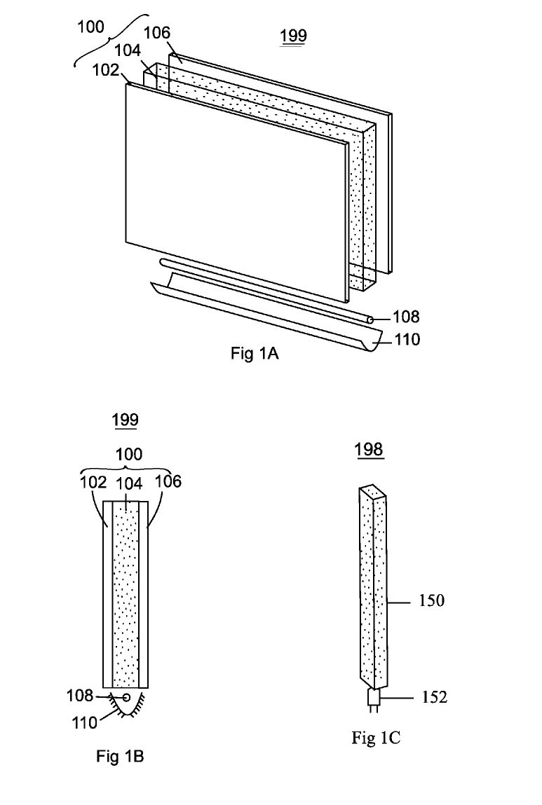

FIG. 1A illustrates a photoluminescent light source 199, according to one embodiment. The photoluminescent light source 199 comprises a light conducting medium 100 which is made up of three sheets joined at their larger faces made of material transparent to light. The central sheet, core 104 is of higher refractive index than the two side sheets, cladding sheets 102 and 106. The cladding sheets could be made of solid, liquid, gas (such as air) or vacuum of a lower refractive index than that of the core 104. Near one edge of the light conducting medium 100, a tube-form or linear primary light source 108 is placed. The primary light source 108 may be an incandescent filament, a photoluminescent or gas discharge tube, or a bank of LEDs, or any other light source. In an embodiment, the light from the primary light source 108 is coupled into the core 104 of the light conducting medium 100 using a focusing reflector 110 or other optical arrangement, such that a maximum amount of light generated by the primary light source 108 enters the core 104 from a bottom edge. Core 104 includes particles of photoluminescent material. The light from the primary light source 108 enters core 104 and undergoes repeated total internal reflection to travel from the primary light source edge to the opposite edge of the core. The core 104 thus acts as a light conducting medium. Some of this light is absorbed by photoluminescent particles and light of a particular spectrum is emitted. Thus, light is emitted over the entire surface of the light conducting medium 100. The emitted light emerges from both of its large faces. In an embodiment, the concentration of photoluminescent particles varies with location in the core 104 so as to achieve uniform illumination over the surface of the light source, or illumination in a desired pattern.

In one embodiment, the particles are of a sparse concentration so as to absorb only a small fraction of light entering one of the large faces of the surface. Hence in this embodiment, light conducting medium 100 is primarily transparent and clear when viewed from one of its faces.

Other embodiments of the present invention comprise a light conducting medium of one of various shapes such as cylinder, parallelepiped, rectangular prism, or rectangular sheet. Light is conducted through the light conducting medium. The light conducting medium includes particles of photoluminescent material. The light conducting medium may or may not have a cladding of a lower refractive index surrounding it.

FIG. 1B illustrates a photoluminescent light source 199 as viewed from the side, according to one embodiment. The photoluminescent light source 199 comprises a light conducting medium 100 made up of core 104 and cladding sheets 102 and 106. The light from the primary light source 108 is absorbed by photoluminescent particles and is emitted over the entire surface of the light conducting medium 100, and will exit both its large faces. In an embodiment, light conducting medium 100 is primarily transparent and clear when viewed from one of its faces.

In one embodiment, photoluminescent particles are small and homogeneously (though not necessarily uniformly) distributed throughout sheet 104.

FIG. 1C illustrates a photoluminescent light source 198, according to one embodiment. The photoluminescent light source 198 comprises a core 150 which is linear in shape, i.e. it is extended in one dimension. The core 150 may be in the shape of a rod, tube, cylinder, or prism with various cross sections. The core 150 may be surrounded by cladding or air or vacuum of a lower refractive index, so that it conducts light by total internal reflection. Near one end of the core 150, a light source 152 is placed. The light from the light source 152 enters the core 150, and is conducted by it. Photoluminescent particles in the core 150 absorb this light and emit light of a particular spectrum.

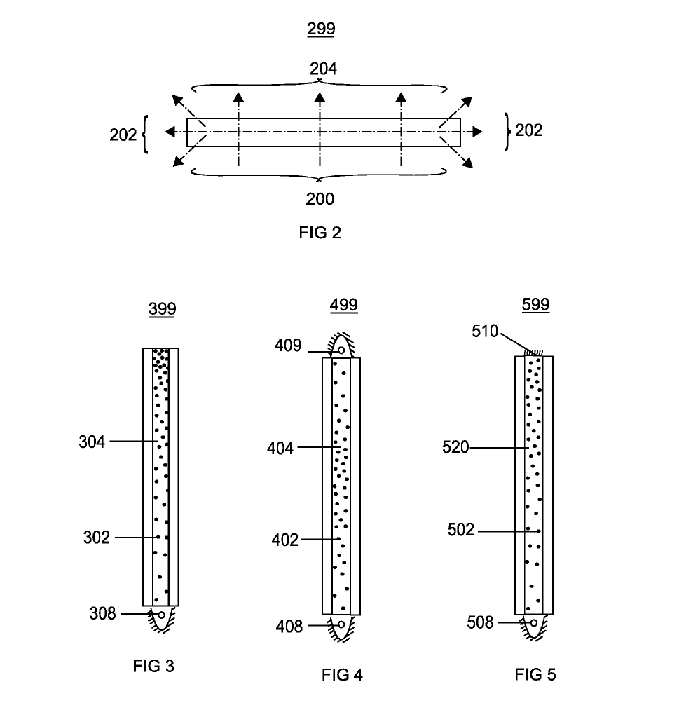

FIG. 2 illustrates an exemplary core element 299 of a core, according to one embodiment. Core element 299 is a small sliver of the core at a particular distance from the light source end of the core. Core element 299 has a very small height. Light 200 enters core element 299. Some of the light gets absorbed or scattered by photoluminescent particles, and the remaining light 204 travels on to the next core element. Some of the energy of the absorbed light is emitted by the photoluminescent particles as light of a particular spectrum. This re-emitted light and scattered light together leaves the light conducting medium as illumination light 202. The fraction of radiant flux absorbed or scattered with respect to the radiant flux 200 entering the core element 299 is the extinctance of core element 299. The total radiant flux going in 200 is the sum of radiant flux absorbed, radiant flux scattered and the radiant flux continuing to the next element 204. The ratio of the extinctance of core element 299 to the height of core element 299 is the extinction density. As the height of core element 299 decreases, the extinction density approaches a constant. This extinction density of core element 299 bears a certain relationship to the concentration of particles of photoluminescent material in the core element 299. The relationship is approximated to a certain degree as a direct proportion. The relationship is easy to evaluate by experimentation, and thus, knowing the concentration of particles of photoluminescent material allows evaluation of the extinction density of element 299, and vice versa.

As the height of core element 299 is reduced, radiant flux of emanating light 202 reduces proportionately. The ratio of radiant flux of emanating light 202 to the height of core element 299, which approaches a constant as the height of the element is reduced, is the emanated linear irradiance of core element 299. The emanated linear irradiance at core element 299 is the extinction density times the radiant flux of incoming light times the efficiency of the photoluminescent material. The efficiency of the photoluminescent material is the ratio of flux of re-emitted or scattered light to the flux of the light that is absorbed or scattered. The gradient of the radiant flux traveling through the core 104 times the efficiency of the photoluminescent material is the negative of the emanated linear irradiance. These two relations give a differential equation. This equation can be represented in the form

“ndP/dh=−nqP=−K”

where:

h is the distance of a core element from the light source end,

P is the radiant flux being guided through that element,

n is the efficiency of photoluminescent material,

q is the extinction density of the element, and

K is the emanated linear irradiance of that element.

This equation is used to find the emanated linear irradiance given the extinction density of each element. This equation is also used to find the extinction density of each element, given the emanated linear irradiance. To design a particular light source with a particular emanated linear irradiance, the above differential equation is solved to determine the extinction density at each core element. From this, the concentration of particles of photoluminescent material at each core element of a core is determined.

If a uniform concentration of particles of photoluminescent material is used in the core, the emanated linear irradiance drops exponentially with distance from the light source. Uniform emanated linear irradiance may be approximated by choosing concentration of photoluminescent particles such that the drop in radiant flux from the edge near the light source to the opposite edge is minimized. To reduce the power loss and also improve the uniformity of the emanated light opposite edge reflects light back into the core. In an alternate embodiment, another primary light source sources light into the opposite edge.

FIG. 3 illustrates a photoluminescent light source 399 with a core having a varied concentration of photoluminescent particles, according to one embodiment. The concentration of photoluminescent particles is varied from sparse to dense from the bottom of core 304 (primary light source end) to the opposite end of core 304. The light from the primary light source 308 is absorbed by photoluminescent particles 302 and is emitted over the entire surface of the light conducting medium, and will exit both its large faces.

To achieve uniform illumination, the extinction density and hence the concentration of the photoluminescent particles is varied along the body of the core 304. The extinction density is varied according to:

q=K/(nA−hK)

where:

A is the radiant flux going into the core 304 and

K is the emanated linear irradiance at each element, a constant number (independent of h) for uniform illumination.

If the total height of the core 304 is H, then H times K should be less than nA, i.e. total radiant flux emanated should be less than total radiant flux going into the light conducting medium times the efficiency of the photoluminescent material, in which case the above solution is feasible. For maximum efficiency, H times K equals nA, and thus the extinction density q approaches infinity as h approaches H, i.e. for higher elements of core 304. In one embodiment of the present invention, H times K is kept only slightly less than nA, so that only a little power is wasted, and the extinction density is finite everywhere.

FIG. 4 illustrates a photoluminescent light source 499 having two primary light sources, according to one embodiment. By using two primary light sources 408 and 409, high variations in concentration of photoluminescent particles 402 in the core 404 is not necessary. The differential equation provided above is used independently for deriving the emanated linear irradiance due to each of the primary light sources 408, 409. The addition of these two emanated linear irradiances provides the total linear irradiance emanated at a particular core element.

Uniform illumination for light source 499 is achieved by extinction density

q=1/sqrt((h−H/2)̂2+C/K̂2)

where sqrt is the square root function,

̂ stands for exponentiation and,

C is equal to nA(nA−HK).

FIG. 5 illustrates a photoluminescent light source 599 having a mirrored core, according to one embodiment. The light from the primary light source 508 enters core 520 and is absorbed by photoluminescent particles 502 and is emitted over the entire surface of the light conducting medium, and will exit both its large faces. By using a mirrored core 520, high variations in concentration of particles of photoluminescent material in the core 520 is not necessary. Top edge 510 of the core 520 is mirrored, such that it will reflect light back into core 520.

Uniform illumination for light source 599 is achieved by extinction density

q=1/sqrt((h−H)̂2+D/K̂2)

where D=4nA(nA−HK).

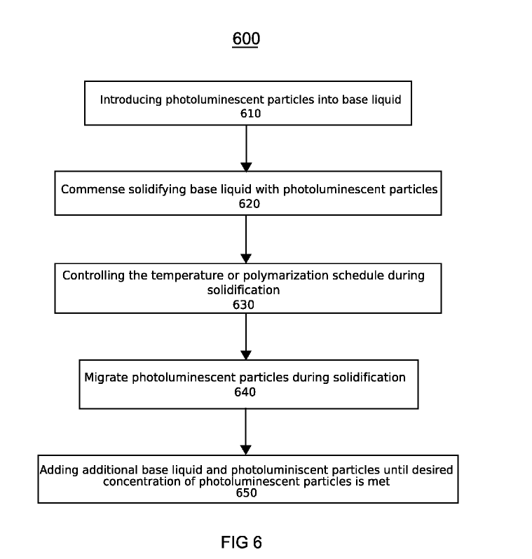

FIG. 6 is a flow diagram illustrating an exemplary core manufacturing process 600, according to one embodiment. Photoluminescent particles are introduced into a base liquid at a homogeneous or varying concentration (610). The base liquid is solidified into a transparent solid in a controlled way (620). The transparent solid eventually forms the body of the core. Solidification is achieved by cooling the base liquid, or by polymerization, or by any similar physical or chemical means. The solidifying process uses a controlled temperature or polymerization schedule, or other means such that the rate of physical diffusion of the particles of photoluminescent material in the base liquid is controlled as a function of time (630). It is possible that the photoluminescent material also undergoes physical and chemical change during the process. During solidification, the photoluminescent particles undergo migration due to physical diffusion and in alternate embodiments, due to buoyant force, convection, non-uniform diffusion rates, and other forces (640). The base liquid is solidified into the core with a predetermined location-dependent concentration of the photoluminescent material. Optionally, more photoluminescent material or base liquid may be introduced throughout this process (650).

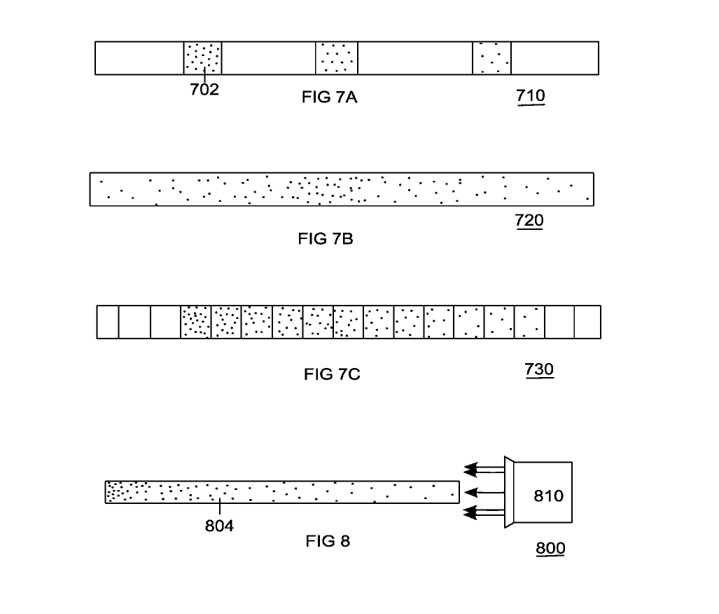

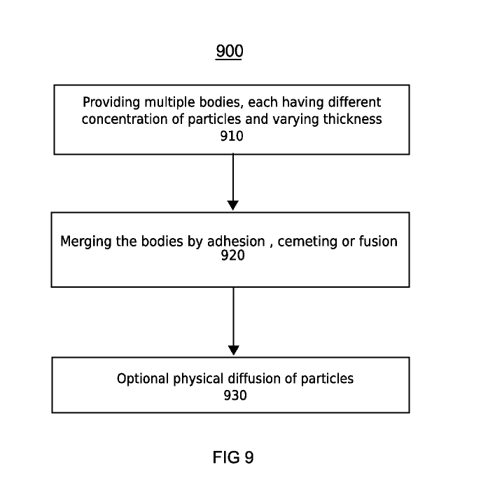

FIG. 7A illustrates an exemplary base liquid 710 having varying concentrations of photoluminescent particles, according to one embodiment. Base liquid 710 includes photoluminescent particles 702 of different concentration levels. The photoluminescent particles 702 are added at different locations of the base liquid 710, which is kept in a rectangular tray of the same size as or larger than the core to be produced. The locations in which the photoluminescent particles are added may be of same or varying sizes. Although only three areas of photoluminescent particles are shown in base liquid 710, hundreds or even millions of such areas may exist over the surface of the base liquid 710. The base liquid 710 is then solidified in a controlled manner to form a core.

In one embodiment, the areas of varying concentration of photoluminescent particles are introduced into the base liquid 710 by nozzles, each nozzle ejecting a photoluminescent particle solution of a different concentration or amount, or for a different amount of time. In another embodiment, the photoluminescent particle areas are made by injecting the photoluminescent material through holes of variable size made in a tray containing photoluminescent material.

FIG. 7B illustrates an exemplary core 720, according to one embodiment of the present invention. During the process of solidification, the areas of photoluminescent particles undergo physical diffusion into each other and into the base liquid to form a continuous gradation in the concentration of particles of photoluminescent material. If the tray in which the core is formed is larger than the required core, the core sheet is cut out of the sheet that is thus formed. To design the photoluminescent particle areas, a physical diffusion process is approximated as a linear, location invariant system, namely a convolution operation. The photoluminescent particle areas are provided in such concentrations that the final concentrations after the convolution have the required concentration pattern. This may be done by deconvolution. According to one embodiment, the impulse response of the convolution operation, necessary to perform the deconvolution, is identified experimentally, or using the knowledge of the temperature schedule, or other controlled solidification process used. Because of non location-invariance at the edges, a linear but not location invariant model may be used in another embodiment. The concentrations of areas of photoluminescent particles are then calculated using linear system solution methods, including matrix inversion or the least squares method.

FIG. 7C illustrates an exemplary base liquid 730 having compartments, according to one embodiment. The base liquid itself is introduced into the setting tray in the form of parts having varying concentration of the photoluminescent material. These parts may be initially separated using partitions, as illustrated in the figure. The partitions are removed after all the parts are ready. These parts then undergo physical diffusion into each other as the base liquid solidifies, to produce a continuous gradation of particles of photoluminescent material concentration.

The above processes (or the ones specified hereinafter) need not be executed in a tray of the form of the final sheet. For example, a whole three dimensional block could be processed at a time and sheets could be cut out of it. Alternately, these processes could take place one after the other on a conveyor belt, with a continuous sheet being formed, which is eventually cut into sheets of the required size. In the case of solidification due to temperature (freezing), various locations of the conveyor belt will have precisely controlled temperature.

In another embodiment, the solidifying sheet of base liquid is in contact on two sides with reservoirs of base liquid with different concentrations of photoluminescent material. A gradient of concentration of particles of photoluminescent material is created across the base liquid. Over a time period, the physical diffusion process settles and a linear gradient is formed. Shorter time periods give different kinds of gradients for particular applications, e.g. for approximating uniform lighting conditions.

In another embodiment, a homogeneous mixture of the base liquid and particles of photoluminescent material is made. As the base liquid solidifies, the sheet is kept at an angle. Depending upon whether the photoluminescent particles are heavier or lighter than the base liquid, they will migrate upwards or downwards under the force of gravity and buoyancy, and thus form a gradation of photoluminescent material particle concentrations. In an embodiment, the angle of the sheet is varied during the process in a controlled fashion.

FIG. 8 illustrates a block diagram of an apparatus 800 for manufacturing a core, according to one embodiment of the present invention. The apparatus 800 comprises a base liquid 804 with a light source 810, A light source 810 projects light energy from one end onto base liquid 804 with a small amount of particles of photoluminescent material in it. The light from light source 810 is of a wavelength that is absorbed by the particles of photoluminescent material and converted at least partly to heat. The particles of photoluminescent material at a particular location receive radiated heat proportional to the extinction density at that location multiplied by the power of radiation that reaches that point. There is even heating of the particles of photoluminescent material when the received heat is a constant. This equilibrium state is the same photoluminescent material concentration gradation used for uniform illumination. If this equilibrium state is not achieved, there is preferential heating up of the particles of photoluminescent material, and the surrounding base liquid. This causes variations in the physical diffusion rate, which causes the particles of photoluminescent material to migrate until equilibrium is achieved. The power of the light source 810 may be reduced, until base liquid 804 solidifies. For evenness in radiated heat, light source 810 is an evenly illuminated surface.

In another embodiment, the temperature of various locations in the base liquid 804 are controlled using temperature control mechanisms. A feedback system (not shown) senses the present concentration of the particles of photoluminescent material, and adjusts the temperature to achieve the required concentration. The present concentration may be sensed by passing light through the forming core, and by sensing the emanated linear irradiance.

In another embodiment, the linear nature of the concentration pattern is achieved by setting up a gradient between reservoirs. Corrections for the non-linear nature of the concentration pattern are achieved by adding areas of varying photoluminescent material concentration. These photoluminescent particle areas undergo physical diffusion at the same time that light source 810 creates microscopic temperature gradients for very small scale corrections.

FIG. 9 is a flow diagram illustrating an exemplary process 900 of manufacturing a core with a varying concentration of photoluminescent particles, according to one embodiment. A number of bodies are provided (910) where each body has a different concentration of photoluminescent particles. Any one of these concentrations could be a zero concentration, i.e. one wherein there are no particles. The thicknesses of the bodies are not constant, but are set to different thicknesses in different parts of the bodies. These bodies are merged together by adhesion, cementing or fusion (920). The merging of the bodies produces a core of the required dimensions, and in every part of the core, a local concentration of particles is obtained, as desired.

In one embodiment, the fusion of the bodies is achieved by merging the bodies while they are in a liquid state. The merged body then solidifies into the final core with a varying concentration of photoluminescent particles. The liquid state may occur by maintaining a certain temperature for the process, wherein the solidification is carried out by cooling. The liquid state may be a monomer or a partially polymerized state, wherein the solidification is carried out by polymerization. The liquid state of the bodies may be a viscous liquid state, such as that of various molten thermoplastics, or that of advanced but incomplete polymerization. The merging bodies may be in different states of viscosity, which may be achieved by different temperatures, or different states of polymerization. For example, one of the merging bodies may be a liquid, and the other bodies may be a viscous liquid or completely solidified object.

In an alternate embodiment, the merging process includes the physical diffusion of photoluminescent particles from one body into other bodies (930). This diffusion process reduces the original difference in particle concentrations in the bodies being merged. The amount of diffusion is controlled such that a required concentration distribution of photoluminescent particles is achieved in the final core. The amount of diffusion may be controlled by controlling the rate of diffusion and the time of diffusion. The rate of diffusion is controlled by controlling the temperature and the viscosity.

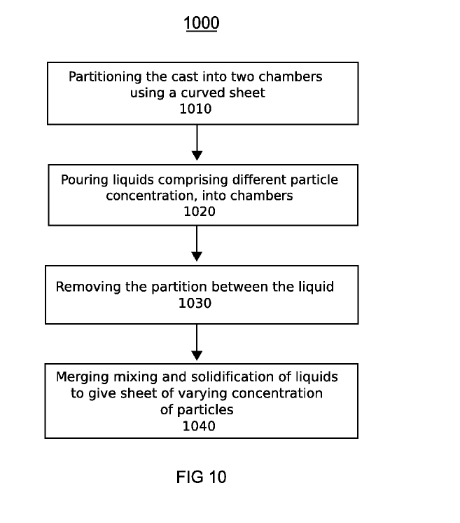

FIG. 10 is a flow diagram illustrating an exemplary process 1000 of manufacturing a core with a varying concentration of photoluminescent particles, according to one embodiment. A cast is partitioned into two chambers using a curved sheet (1010). A liquid containing within it a certain concentration of photoluminescent particles is poured into one chamber of the cast (1020). In the second chamber of the cast, a liquid having a different concentration of photoluminescent particles is poured. The curved surface is removed at a predefined time or when the liquids attain a predefined viscous state (1030). In another embodiment, the liquids act as solvents and dissolve the curved sheet. The liquids merge, mix and eventually solidify to give a solid of varying concentration of photoluminescent particles (1040). Solidification is achieved by cooling the liquid, or by polymerization, or by any similar physical or chemical process. The solidification process uses a controlled temperature or polymerization schedule, or other process such that the rate of physical diffusion of the particles in the liquid is controlled as a function of time. It is possible that the particles also undergo physical and chemical change during the process. During solidification, the particles undergo migration due to physical diffusion and in alternate embodiments, due to buoyant force, convection, non-uniform diffusion rates, and other forces.

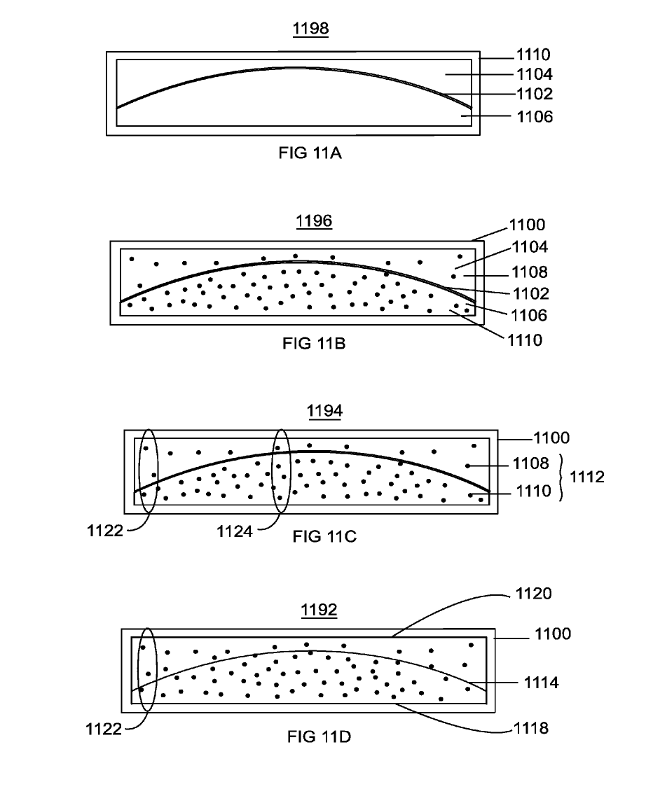

FIG. 11A illustrates a partitioned cast 1198, according to one embodiment. Curved sheet 1102 partitions the cast 1100 into two chambers 1104 and 1106. The shape of the curved sheet is designed so as to get the required particle concentration distribution at the end of the manufacturing process.

FIG. 11B illustrates a partitioned cast 1196 filled with liquid, according to one embodiment. Curved sheet 1102 partitions the cast 1100 into two chambers 1104 and 1106. The chamber 1104 is filled with liquid 1108 having a particular particle concentration. The chamber 1106 is filled with liquid 1110 having a different concentration of particles. Any one of these concentrations could be a zero concentration, i.e. one wherein there are no particles. According to one embodiment, the curved sheet 1102 is manufactured by solidification of the same liquid as 1108 or 1110. This allows the curved sheet 1102 to dissolve into the liquid material.

FIG. 11C illustrates a cast with partition removed 1194, according to one embodiment. The liquids 1108 and 1110 start solidifying and become more viscous. The curved sheet separating the cast 1100 into two chambers is removed at a predefined time or when the liquids attain a predefined viscous state. In an embodiment, the curved sheet 1102 is removed mechanically. In another embodiment, the liquids act as a solvent and dissolve and hence remove the curved sheet 1102. The dissolution of curved sheet 1102 may be achieved by heating the liquids.

After the removal of the curved sheet 1102, the resulting body 1112 has a varying concentration of photoluminescent particles in it. For example, the average concentration of photoluminescent particles in an area 1122 is different from the average concentration of photoluminescent particles in an area 1124. This is so because the proportion of the two bodies 1108 and 1110 are different in these two areas. In an embodiment, the body 1112 is solidified in this form to form a core with a varying concentration of photoluminescent particles. In another embodiment, diffusion of the bodies 1108 and 1110 is performed.

FIG. 11D illustrates an apparatus 1192 with diffused bodies, according to one embodiment. The liquids in the partitioned cast solidify to give a core 1114 having the required particle concentration distribution. In an embodiment, the solidification is done by polymerization or by cooling of the liquid. In an embodiment, the liquid is a plastic monomer which is then polymerized.

In an embodiment, during the process of solidification, the particles undergo physical diffusion into the liquid body before it solidifies into core 1114. Such a diffusion causes a local homogenization of particle concentrations. For example, the particles in a local area 1122 have a more homogeneous distribution in the core 1114 than the particles in the same area 1122 at the moment the curved sheet was removed. The amount of diffusion is controlled in such a way as to achieve this local homogenization along the thickness of the core 1114, but without homogenizing the particle distribution in the entire core 1114. The amount of diffusion is controlled by controlling the rate and time of diffusion.

When particles undergo physical diffusion, the curved sheet that initially partitions the cast 1100 is designed as follows. The physical diffusion process is approximated as a linear, location invariant system, namely a convolution operation. The initial concentration pattern is arranged such that after the physical diffusion process, the final concentration pattern is the required concentration pattern. This may be done by deconvolution. This initial concentration pattern is then effected using the curved sheet. The initial concentration at any point in the cast 1100 is a weighted average of the concentration in the liquids in the two partitions, weighted by the distances of the curved sheet at that point from the cast boundaries 1120 and 1118. According to one embodiment, the impulse response of the convolution operation, necessary to perform the deconvolution, is identified experimentally, or by using the knowledge of the temperature schedule, or other controlled solidification process used. Because of non location-invariance at the edges, a linear but not location invariant model may be used in another embodiment. The initial particle concentration pattern is then calculated using linear system solution methods, including matrix inversion or the least squares method.

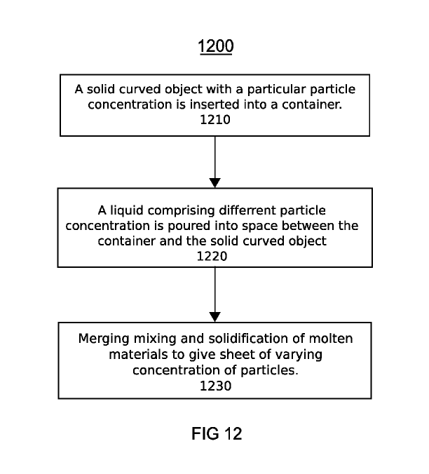

FIG. 12 is a flow diagram illustrating an exemplary process 1200 of manufacturing a core with a varying concentration of photoluminescent particles, according to one embodiment. A curved object having a particular concentration of particles is inserted in a container (1210). The curved object may be manufactured by processes such as casting, injection molding, mold polymerization, machining, etc. Processes such as casting, injection molding and mold polymerization may be performed in the container itself, so that the formed curved object is already present in the container. A liquid having a particular particle concentration is poured into the space between the container and the curved object (1220). The liquid merges and mixes with the curved object, and eventually solidifies (1230). In an embodiment, the curved object diffuses into the liquid before complete solidification of the liquid. The diffusion may be caused by the curved object partially or completely dissolving in the liquid. This dissolution may be caused by heat, or by physical dissolution of the solid in the liquid. The liquid eventually solidifies to give a solid core with a varying concentration of particles. Solidification is achieved by cooling the liquid, or by polymerization, or by other physical or chemical means. The solidification process uses a controlled temperature or polymerization schedule, or other process such that the rate of physical diffusion of the solid in the liquid is controlled as a function of time. It is possible that the particles undergo physical and chemical change during the process. During solidification, the particles undergo migration due to physical diffusion and in alternate embodiments, due to buoyant force, convection, non-uniform diffusion rates, and other forces.

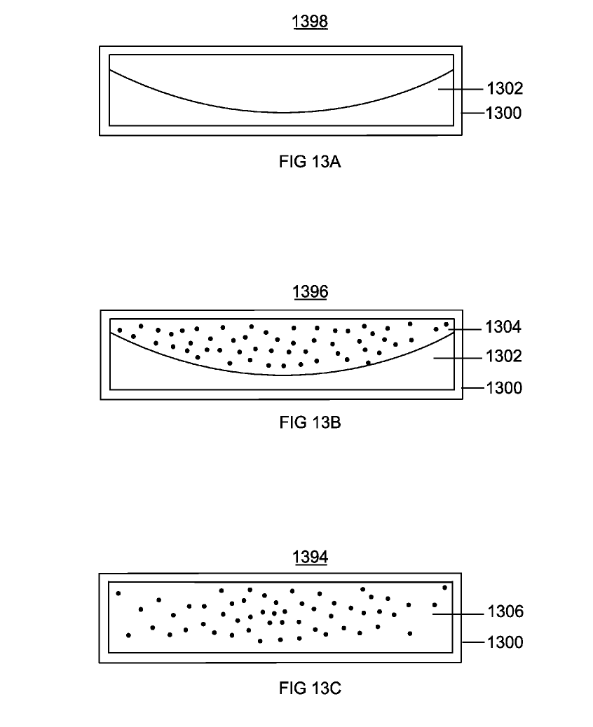

FIG. 13A illustrates a container with curved object 1398, according to one embodiment. A curved object 1302 having a particular concentration of photoluminescent particles is inserted in a container 1300. The shape of curved object 1302 is designed for a required particle concentration distribution at the end of the manufacturing process. The curved object 1302 along with the container 1300 now acts as a cast in the manufacturing process.

FIG. 13B illustrates a container with curved object 1396 filled with liquid, according to one embodiment. A liquid 1304 with a particular particle concentration is poured in the cast formed by container 1300 and curved object 1302. The concentration of particles in liquid 1304 is different from the concentration of particles in curved object 1302.

FIG. 13C illustrates a container with solidifying liquid 1394, according to one embodiment. The liquid solidifies and merges with the curved object in container 1300 to render a core 1306 having the required particle concentration distribution. In an embodiment, the solidification is done by polymerization or by cooling of the liquid. In an embodiment, the liquid is a plastic monomer which is then polymerized.

In an embodiment, curved object diffuses into the liquid, before complete solidification of the liquid. The diffusion may be caused by the curved object partially or completely dissolving in liquid. The liquid may be heated to cause this dissolution.

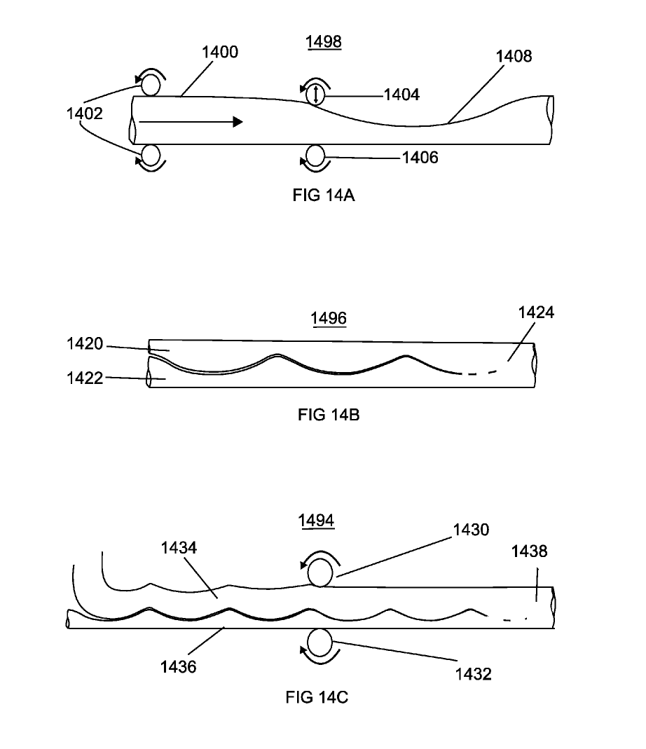

FIG. 14A illustrates an exemplary corrugated sheet manufacturing device 1498, according to one embodiment. A molten sheet 1400 has a particular concentration of photoluminescent particles. Sheet 1400 is passed through a moving pair of feeder rollers 1402. These rollers 1402 feed the sheet 1400 through pinch roller 1404 and guide roller 1406. The pinch roller 1404 moves up and down according to a predefined function of time. This movement of pinch roller produces a corrugated sheet 1408. The movement of rollers is defined according to the pattern of corrugations required.

The device 1498 for manufacturing a corrugated sheet may be used to manufacture a curved object, to be inserted into a container to form a cast. The curved object is produced by cutting the corrugated sheet. Alternately, the corrugated sheet 1408 is merged with other corrugated sheets in a continuous process, as described below. The corrugation pattern of sheet 1408 is designed so as to get the required distribution of particle concentration at the end of the manufacturing process.

FIG. 14B illustrates an exemplary core manufacturing device 1496, according to one embodiment. A corrugated sheet 1420 of a particular particle concentration is merged with a matching corrugated sheet 1422 with a different particle concentration to give a core sheet 1424 with a varying concentration of particles. The corrugations on sheet 1420 and sheet 1422 are matched so as to merge and produce a core sheet 1424 of required shape. In an embodiment, the two sheets are in a molten state during the merging process, and fuse together due to heat. Such fusion may include diffusion of the particles from each sheet into the other. Diffusion may also be achieved by dissolution using a solvent. In an alternate embodiment the corrugated sheets are cemented by adhesive material.

The core sheet 1424 has a continuously varying concentration of particles. The core sheet 1424 may be cut into smaller pieces to form cores with continuously varying concentration of photoluminescent particles.

FIG. 14C illustrates an exemplary core manufacturing device 1494, according to one embodiment. A corrugated sheet 1436 of a particular particle concentration is merged with liquid 1434 having a different particle concentration to give a core sheet 1438 with varying concentration of particles. In an embodiment, the sheet 1436 and liquid 1434 fuse together due to heat. Such fusion may include diffusion of the particles from each sheet into the other. The roller 1430 removes undulations, and makes the surface of sheet 1438 flat. The roller 1432 acts as a guide for the sheet 1436. The core sheet 1438 has a continuously varying concentration of particles. This sheet may be cut into smaller pieces to form cores with continuously varying concentration of photoluminescent particles.

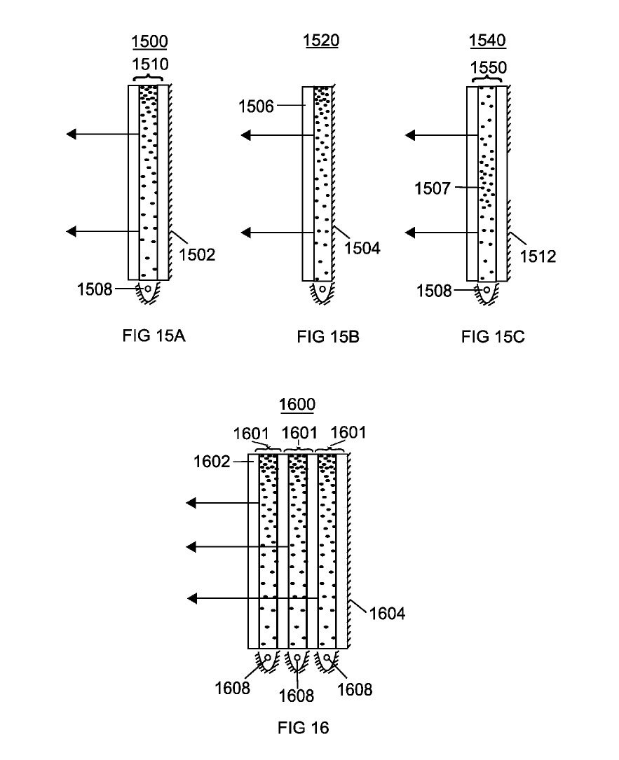

FIG. 15A illustrates a light source 1500 that emanates light from a single surface, according to one embodiment. A mirror 1502 is placed adjacent to a light conducting medium 1510. The light from the primary light source 1508 is absorbed by photoluminescent particles and is emitted over the entire surface of the light conducting medium 1510, and will exit its unmirrored surface. The mirror 1502 may be a specular or diffuse mirror. In another embodiment, a sheet or film containing particles of photoluminescent material is disposed on at least one of the surfaces of the light conducting medium 1510. The mirror 1502 might be a partially silvered mirror, so as to let some light through it and objects on the other side may be viewed. This apparatus may be used as a one-way glass. The system may also be used for photography purposes, such that the illumination is from the same direction as the camera.

FIG. 15B illustrates a light source 1520 that emanates light from a single surface, according to one embodiment. In this embodiment, only one cladding sheet 1506 is used and the mirror is disposed directly on the core 1504. The minor helps in guiding the light within core 1504, as well as directing it to a single output surface.

FIG. 15C illustrates a partially mirrored light source 1540, according to one embodiment. A mirror 1512 is placed adjacent to a light conducting medium 1550. The mirror 1512 has a gap or unmirrored portion in it. The light from the primary light source 1508 is absorbed by photoluminescent particles and is emitted over the entire surface of the light conducting medium 1550. A larger concentration of the particles of photoluminescent material is used in the area 1507 in front of the unmirrored portion to compensate for the loss in illumination power in this part. To achieve evenness of illumination from various angles of viewing, a continuous gradation in the reflectivity of the minor and a continuous gradation in the photoluminescent material concentration is used. A camera or viewer may be placed behind the unmirrored portion, so as to be able to capture images through the light source 1540.

FIG. 16 illustrates an exemplary light source 1600 with multiple light conducting mediums, according to one embodiment of the present invention. Two or more light conducting mediums 1601 are placed next to each other. Each light conducting medium is transparent and illumination due to all the light conducting mediums is visible on the viewable surface 1602. Also each light conducting medium contains particles of photoluminescent material of different characteristics and with different concentrations patterns. Various illumination effects may be achieved. The viewable surface 1602 of light source 1600 is a light source emitting light comprising combinations of different wavelengths in different magnitudes. Back-mirror 1604 reflects the light emitted by light conducting mediums 1601. Light of variable light intensity can also be obtained by changing power of primary light sources 1608. The power of primary light sources 1608 can be controlled individually to give light of various intensities and spectra. In an embodiment, a single primary light source is used for all the light conducting mediums 1601. A lens system or other optical arrangement may be used to produce a focused beam, which creates a luminaire of varying color, which is very energy efficient, and can produce a continuous gradation of color, and also continuous changes of color.

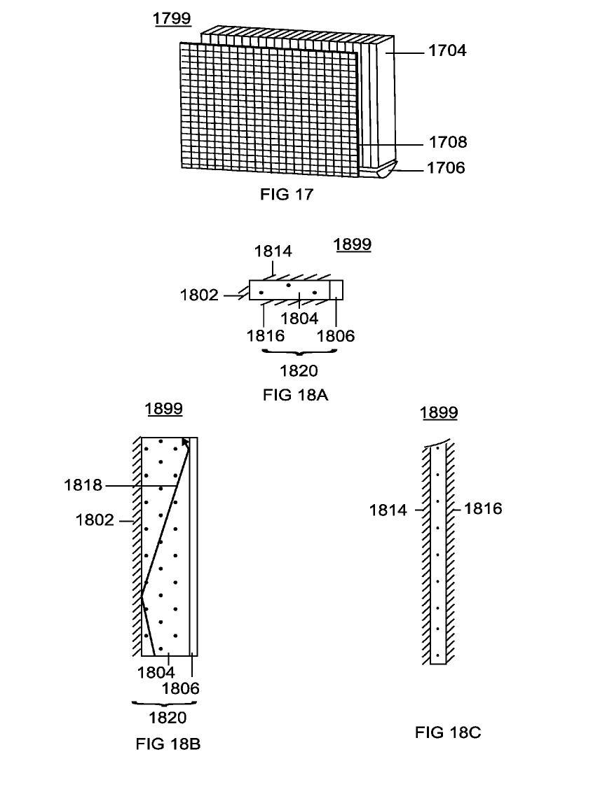

FIG. 17 illustrates a block diagram of an exemplary backlight display 1799, according to one embodiment. Image is displayed on a flat panel screen 1708. In an embodiment, the flat panel screen 1708 is an LCD screen. A linear light source 1706 is coupled to a multicolored illuminator 1704. In an embodiment 1706 consists of a reflector such as a parabolic reflector. Linear light source 1706 emits a light of particular spectrum. In one embodiment, it is ultraviolet. Multicolored illuminator 1704 comprises a plurality of light conducting mediums with photoluminescent particles, henceforth referred to as illuminator columns. Each illuminator column illuminates one column of pixels. Different illuminator columns emanate light of different colors since they include particles of different photoluminescent material. Thus, light illuminating different pixel columns is of different colors.

FIG. 18A is the top view of an illuminator column 1899, according to one embodiment. Core 1804, cladding sheet 1806 and mirrors 1802, 1814 and 1816 together form illuminator column 1899. Core 1804 may be surrounded on all sides by cladding. Light is guided inside the light conducting medium 1820 by reflection or total internal reflection. Core 1804 has a sparse distribution of particles of photoluminescent material in it. Back-mirror 1802 reflects light from the back surface. Side-mirrors 1814, 1816 reflect light from the side surfaces. Side-mirrors 1814 prevent light from leaking into adjacent illuminator columns. The mirrors 1802, 1814 and 1816 may be any well known means of reflecting light, including metallic surfaces, distributed Bragg reflectors, hybrid reflectors, total internal reflectors or omni-direction reflectors.

FIG. 18B is the cross-sectional side view of an illuminator column 1899, according to one embodiment. Core 1804, cladding sheet 1806, mirror 1802 and side mirrors together form illuminator column 1899. Light ray 1818 is guided inside the light conducting medium 1820 by reflection or total internal reflection.

FIG. 18C is the front view of an illuminator column 1899, according to one embodiment. Side-mirrors 1814, 1816 reflect light from the side surfaces.

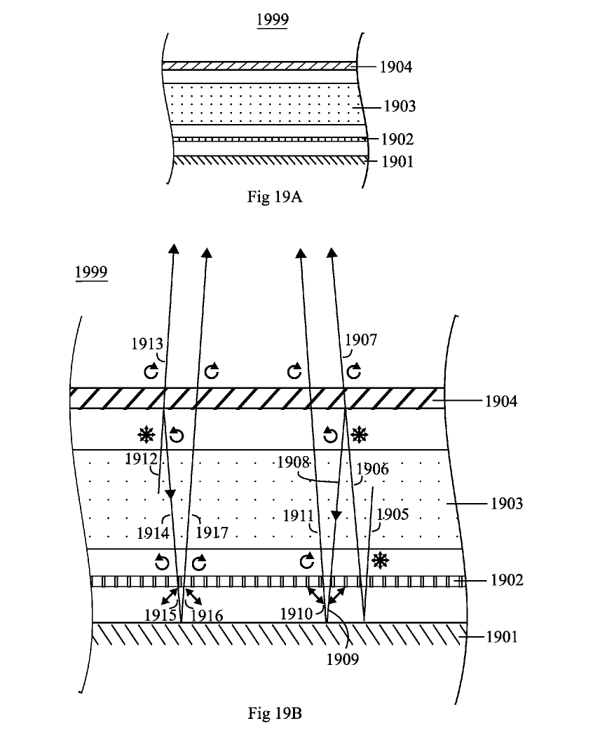

FIG. 19A illustrates a section of a polarized light source 1999, according to one embodiment. The polarized light source comprises a minor 1901, a quarter wave retarder 1902 placed in front of mirror 1901, a transparent light source 1903 comprising particles of photoluminescent material placed in front of the quarter wave retarder 1902 and a reflecting circular polarizer 1904 placed in front of the transparent light source 1903. The reflecting circular polarizer 1904 allows one circular polarization to pass through it, but reflects back the other circular polarization. The apparatus 1999 is an energy efficient light source which emits circularly polarized light.

The transparent light source 1903 may be a light conducting medium with a sparse concentration of photoluminescent particles.

FIG. 19B illustrates a section of a polarized light source 1999, depicting polarization states of exemplary light rays, according to one embodiment. Light is extracted from the transparent light source 1903 from both its faces. Light 1912 is extracted from the front face of the transparent light source 1903. Extracted light 1912, which is unpolarized, is incident on the reflecting polarizer 1904. Circularly polarized light component 1913 of light 1912 of a particular handedness emerges out from the reflecting polarizer 1904. Circularly polarized light component 1914 of light 1912 of the opposite handedness is reflected back by the polarizer 1904. Circularly polarized light component 1914 passes through the transparent light source 1903. The light source 1903 being transparent, the polarization state of light 1914 is retained. Further, light 1914 is incident on the quarter wave retarder 1902. Circularly polarized light 1914 passes through the quarter wave retarder 1902 and gets linearly polarized. Linearly polarized light 1915 is reflected from the mirror surface 1901. Mirror reflection of light 1915 retains its polarization state. Reflected linearly polarized light 1916 passes through the quarter wave 1902 and becomes circularly polarized in a handedness opposite to that of light 1914. Circularly polarized light 1917 passes through the transparent light source 1903 and is incident on the reflecting polarizer 1904. The light source 1903 being transparent, the polarization state of light 1917 is retained. Light 1917 is circularly polarized in a handedness which is transmitted by the reflecting polarizer 1904. Light 1917 passes through the reflecting polarizer 1904. The light 1912 extracted from the front face of the transparent light source 1903 gets circularly polarized and emanates out from the reflecting polarizer 1904.

Light 1905 depicts exemplary light which is extracted from the back face of the transparent light source 1903. Extracted light 1905, which is unpolarized, passes through the quarter wave retarder 1902 and remains unpolarized. Further, light 1905 reflects from the mirror 1901. Reflected light 1906, which is unpolarized, passes through the transparent light source 1903. Further, light 1906 is incident on the reflecting polarizer 1904. Circularly polarized light component 1907 of light 1906 of a particular handedness emerges out from the reflecting polarizer 1904. Circularly polarized light component 1908 of light 1906 of the opposite handedness is reflected back by the polarizer 1904. Circularly polarized light component 1908 passes through the transparent light source 1903. The light source 1903 being transparent, the polarization state of light 1908 is retained. Further, circularly polarized light component 1908 passes through the quarter wave retarder 1902 and gets linearly polarized. Linearly polarized light 1909 is reflected from the mirror surface 1901. Mirror reflection of light 1909 retains its polarization state. Reflected linearly polarized light 1910 passes through the quarter wave retarder 1902 and becomes circularly polarized light 1911 in a handedness opposite to that of circularly polarized light component 1908. Circularly polarized light 1911 passes through the transparent light source 1903 and is incident on the reflecting polarizer 1904. The light source 1903 being transparent, the polarization state of light 1911 is retained. Light 1911 is circularly polarized in a handedness which is transmitted by the reflecting polarizer 1904. Light 1911 passes through the reflecting polarizer 1904. The light 1905 extracted from the back face of the transparent light source gets circularly polarized and emanates out from the reflecting polarizer 1904. Light extracted from both the faces of the transparent light source emerges out from the apparatus in a circularly polarized state.

In an embodiment, a reflecting linear polarizer is used in place of reflecting circular polarizer 1904. Reflecting linear polarizer is a polarizer which passes one linearly polarized component of light, and reflects back the other linearly polarized component of light.

In an embodiment, the quarter wave retarder 1902 is placed in between the transparent light source 1903 and reflecting polarizer 1904, or reflecting linear polarizer.

Uses

One use of the present apparatus is as a source of illumination in homes, offices, factories, for photography, etc. and as a laboratory source of light.

Another use of the present apparatus and method is as a backlight for flat panel displays such as LCD screens. Such screens are commonly used in laptop and desktop monitors, and the backlight of the display is a uniformly illuminated surface.

For some applications, a non-uniform emanation of light may be preferred. A light with a gradation of color (hue, saturation, luminance or the spectrum in general) may be achieved, using a system having two photoluminescent light sources having two emission spectra and different emission patterns. This system is more energy efficient than systems using color filters.

The present apparatus can be used for architectural and civil lighting (including home, office and public spaces), for photography including medical photography, and for cinematography and theater. Uniform light sources are also useful as standard light sources for calibration and laboratory purposes.

The transparency of the present apparatus allows a photographer to photograph an object from behind the light source, giving shadowless photos, which are of special importance in medical (especially orthodontic) photography. A camera may capture an image from behind a lighted flat screen display having a backlight comprising the present apparatus.

The present apparatus and method may also be used for aesthetic and artistic purposes. For example, primary light sources of different colors at two opposing edges of the light conducting medium provide a light source with a continuous gradation in hue. A specific application of such an appliance may be made as the cyclorama or skycloth in theatre and movie productions, to simulate the gradation of hue in the sky.

Various other gradations in luminosity and hue may be achieved.

According to another embodiment, the present apparatus and method replaces daylight with an artificial light source from the same direction. Automatic compaction is also provided since separate space is not needed for a daylight aperture and for an artificial light source. Another embodiment provides privacy when required as the transparent surface becomes a light source that obscures the view through it. Similarly, a half-mirror or one-way-glass may be augmented by a transparent light source on one end of the half-minor, making it hard to view objects in one direction, and easy to view them in the opposite direction.

An apparatus and method for providing a photoluminescent light source is disclosed.

It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

1. An apparatus comprising:
a core, and
a light source placed near one end of the core,
wherein the core conducts light through it, and
the core includes particles of photoluminescent material.

2. The apparatus of claim 1, wherein the core is a sheet.

3. The apparatus of claim 1, wherein the core is linear.

4. The apparatus of claim 1 wherein the particles of photoluminescent material are present in a uniform concentration in the core.

5. The apparatus of claim 1 wherein the particles of photoluminescent material are varied along the core.

6. The apparatus of claim 1 wherein the core emits light in a predetermined light emanation pattern.

7. The apparatus of claim 1 wherein the apparatus is primarily transparent and clear when viewed from outside.

8. The apparatus of claim 7 further comprising a reflecting polarizer, a wave retarder and a reflector.

9. An apparatus comprising a plurality of light conducting mediums with photoluminescent particles, at least two light conducting mediums having photoluminescent particles that emit different spectra, and a light source placed near one end of the light conducting mediums.
